(19) United States
(12) Patent Application Publication
(10) Pub. No.: US 2009/0084238 A1
(43) Pub. Date: Apr. 2, 2009

(54) Fence Assembly for a Cutting Machine

(76) Inventor: Lee-Cheng Chang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/193,083

(22) Filed: Aug. 18, 2008

(30) Foreign Application Priority Data
Sep. 28, 2007 (TW) 96216197

(51) Int. Cl. B27B 27/10

(52) U.S. Cl. 83/441.1; 83/522.11; 83/449

(57) ABSTRACT

A fence assembly for a cutting machine includes a body which is adapted to guide a workpiece on a worktable during cutting process. A coupling mechanism includes a sliding bracket slidably mounted to a rail and connected to the body such that movement of the bracket along the rail causes movement of the body relative to the worktable. The sliding bracket is adapted for providing stable sliding movement with respect to the rail and engaging with at least three sides of the rail. A locking mechanism is utilized for selectively locking and unlocking the sliding bracket on the rail.

### BACKGROUND OF THE INVENTION

1. Field of the Invention

The present invention relates to the field of a cutting machine, in particular, to a fence assembly for use with a cutting machine.

2. Description of the Related Art

Referring to Taiwan Pat. No. M316116, a fence assembly for a cutting machine includes a fence body 50, a bracket 42 moveable relative to a rail 40 and connected in proximity to an end of the fence body 50. Accordingly, when the bracket 42 moves with respect to the rail 40 the fence body 50 is moved across a worktable of the cutting machine. In addition, a locking mechanism 60 is utilized to lock and unlock the movement of the bracket 42. A shortcoming with this fence assembly is that the bracket 42 is liable to move in a direction transverse to a longitudinal axis of the rail 40 and results the fence body 50 to move in the corresponding direction. In this regard, the bracket 42 would render a side thereof corresponding to a lateral side of the rail 40 disengage with this lateral side of the rail 40, and when the bracket 42 is to be locked on the rail 40, there would be no sufficient force to securely lock the bracket 42. Furthermore, it is noted that the bracket 42 of this configuration lacks ability to move stably on the rail 40 after a repeated use.

The present invention is, therefore, intended to obviate or at least alleviate the problems encountered in the prior art.

### SUMMARY OF THE INVENTION

According to the present invention there is provided, a fence assembly for a cutting machine having a worktable, a rail and a ruler includes a body which is adapted to guide a workpiece on the worktable during cutting process. A coupling mechanism includes a sliding bracket slidably mounted to the rail and connected to the body such that movement of the bracket along the rail causes movement of the body relative to the worktable. The sliding bracket includes a cross section defining a first, a second and a third sides engaging with the rail for providing stable sliding movement with respect to the rail and engaging with at least three sides of the rail. A locking mechanism is utilized for selectively locking and unlocking the sliding bracket on the rail such that the body is prevented from movement with respect to the worktable when the sliding bracket is locked and the body is enabled to move with respect to the worktable when the sliding bracket is unlocked.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The present invention will be described with reference to the accompanying drawings which assist in illustrating the pertinent features thereof, in which:

FIG. 1 is a perspective view of a cutting machine equipped with a fence assembly of the present invention FIG. 2 is a partial perspective view of FIG. 1.

FIG. 3 is an exploded perspective view of the fence assembly of the present invention.

FIG. 4 is a partial, side, cross-sectional view of FIG. 2.

FIG. 5 is similar to FIG. 4, but illustrating the fence assembly is enabled to move with respect to a worktable of the cutting machine.

FIG. 6 is a partial, enlarged view of FIG. 2.

FIG. 7 is similar to FIG. 6, but illustrating calibration of the fence assembly.

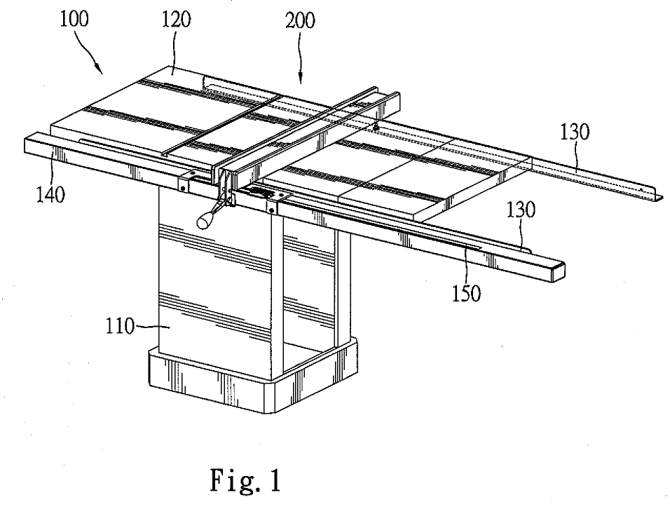

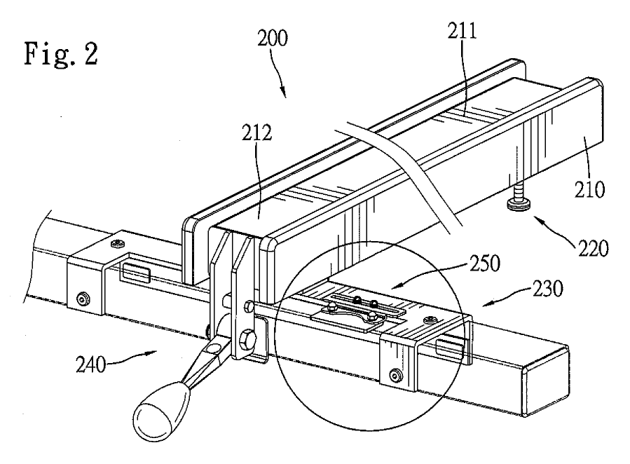

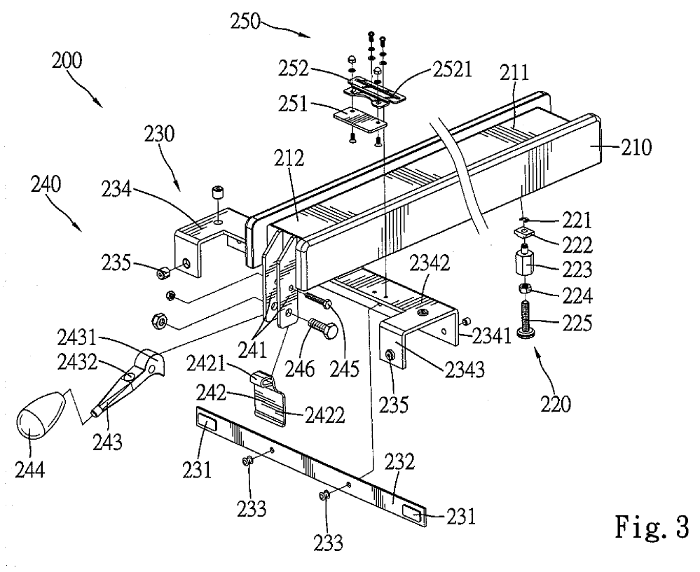

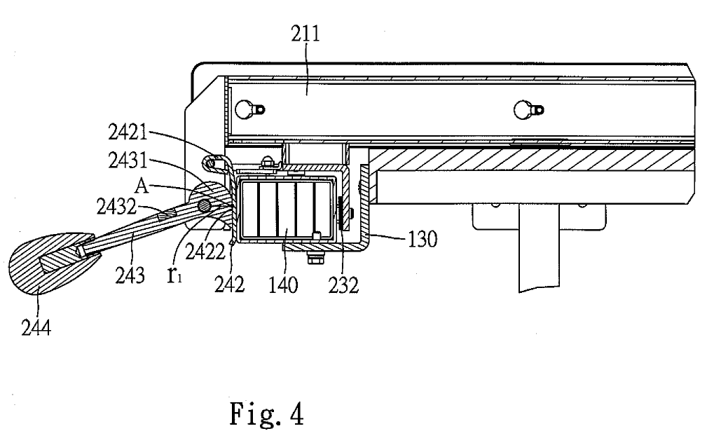

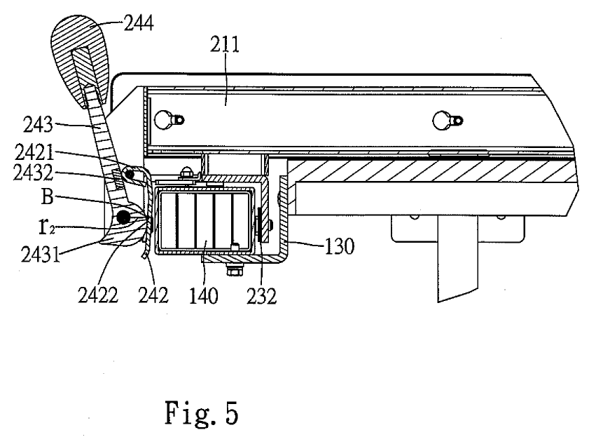

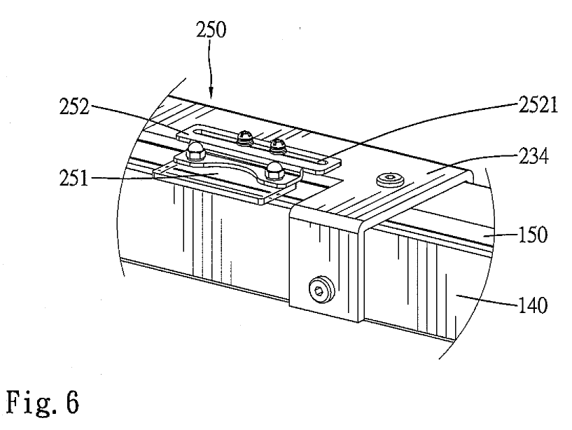

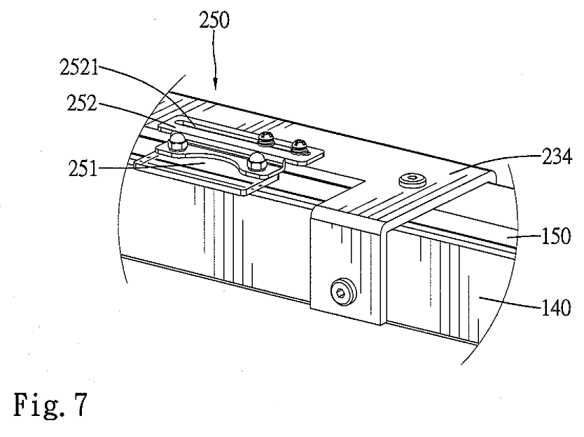

### DETAILED DESCRIPTION OF THE PREFERRED EMBODIMENT

Referring to the drawings, a fence assembly 200 in accordance with the present invention is used for a cutting machine 100. Preferably, the cutting machine 100 includes a base 110 supporting a worktable 120 off the ground. In addition, the cutting machine 100 further includes two supporting members 130 parallel to a longitudinal axis of the worktable 120 and connected to two opposite edges of the worktable 120, respectively, a rail 140 supported by one of the two supporting members 130, and a ruler 150.

The fence assembly 200 of the present invention includes a body 210 which is adapted to guide a workpiece on the worktable 120 during cutting process. As shown in the drawings, the body 210 is mounted transverse to the longitudinal axis of the worktable 120.

The fence assembly 200 further includes a lifting mechanism 220 in proximity to a first end 211 of the body 210 for adjusting a height between the body 210 and the worktable 120. In the preferred embodiment, the lifting mechanism 220 includes a sliding member 222, a polygonal member 223 connected to the sliding member 222, a clip 221 for preventing disengagement of the sliding member 222 and polygonal member 223, a screw 225 having one end threadly engaged with the polygonal member 223 and another end supported by another of the two supporting members 130, and a nut 224 threadly engaged with the screw 225.

The fence assembly 200 also includes a coupling mechanism 230 connected in proximity to a second end 212 of the body 210. The coupling mechanism 230 includes a sliding bracket 234 slidably mounted to the rail 140 and connected to the body 210 such that movement of the bracket 234 along the rail causes movement of the body 210 relative to the worktable 120. Further, the sliding bracket 234 has a cross section defining a first, a second and a third sides 2341, 2342 and 2343 corresponding with the generally rectangular cross-sectioned rail 140 for providing stable sliding movement with respect to the rail 140; and the second side 2342 interconnects the first and third sides 2341 and 2343, and the first side 2341 is spaced from the third side 2343. Preferably, the first, second and third sides 2341, 2342 and 2343 correspond to three sides of the rail 140. Moreover, an engaging member 232 with at least one auxiliary engaging member 231 and at least one cushioning member 233 is disposed between the first side 2341 of the sliding bracket 234 and the rail 140 and is attached to the sliding bracket 234 such that the sliding bracket 234 and the rail 140 are engaged in a manner that movement of the sliding bracket relative to the rail 140 is stable. Preferably, the engaging member 232 has a length substantially equal to a length of the first side 2341 of the sliding bracket 243; and the at least one auxiliary engaging member 231 is disposed near an end of the engaging member 232. Moreover, at least one controlling member 235 is adapted to be inserted through the sliding bracket 234 to abut the rail 140 to thereby make appropriate tightness between engagement of the sliding bracket 234 and rail 140.

The fence assembly 200 further includes a locking mechanism 240 pivotally connected to the second end 212 of the body 210 for selectively locking and unlocking the sliding bracket 234 on the rail 140 such that the body 210 is prevented from movement with respect to the worktable 120 when the sliding bracket 234 is locked and the body 210 is enabled to move with respect to the worktable 120 when the sliding bracket 234 is unlocked.

The locking mechanism 240 includes a pivoting member 242 having a substantially uniform thickness and including a rolled hooked section 2421 as a pivot and a planar pivoting section 2422 adapted to pivot with respect to the hooked section 2421. Moreover, the hooked section 2421 includes a first fastener 245 inserted threrethrough for joining the pivoting member 242 to a bracket extended from the second end 212 of the body 10.

The locking mechanism 240 also includes a handle 243 including a grip 244 mounted to an end thereof for a user to hold to operate the handle 243 and a cam 2431 at another end thereof which urges the pivoting member 242 to selectively engage with and disengage from the rail 140 such that when the pivoting member 242 is engaged with the rail 140 the sliding bracket 234 is locked and when the pivoting member 242 is disengaged from the rail 140 the sliding bracket 234 is unlocked. Moreover, the cam 2431 includes a second fastener 246 inserted threrethrough for joining the handle 243 to the bracket 241.

As mentioned, the pivoting member 242 is adapted to selectively engage with and disengage from the rail 140 by the cam 2431. Particularly, the cam 2431 defines a first and a second points A and B at the periphery thereof, respectively, and of which the first point A and the second fastener 246 defining a first radius r1 and the second point B and the second fastener 246 defining a second radius r2, with the first radius r1 being longer than the second radius r2. Also, when the pivoting member 242 and the rail 140 are engaged, the first point A is abutted by the pivoting section 2422 of the pivoting member 242, and when the pivoting member 242 and the rail 140 are disengaged, the second point B is abutted by the pivoting section 2422 of the pivoting member 242.

In addition, the handle 243 includes a magnet 2432 which selectively attaches and detaches the hooked section 2421 such that when the pivoting member 242 and the rail 140 are engaged the magnet 2432 and the hooked section 2421 of the pivoting member 242 are detached, and when the pivoting member 242 and the rail 140 are disengaged the magnet 2432 and the hooked section 2421 are attached in order to keep the pivoting section 2422 away from the rail 140.

The fence assembly 200 further includes a measuring apparatus 250 attached to the sliding bracket 234, and which includes a measuring indication window 251 for user to read and get measurement from the ruler 150, and at least one calibrating member 252 for calibration of the measuring apparatus 250.

Therefore, according to the forgoing, it is understood that in one aspect of the present invention the sliding bracket 234 is configured to provide a stable sliding movement with respect to the rail 140 and to engage with at least three sides of the rail 140.

In a further aspect of the present invention, when the pivoting member 242 and the rail 140 are engaged the magnet 2432 and the hooked section 2421 of the pivoting member 242 are detached, and when the pivoting member 242 and the rail 140 are disengaged the magnet and the hooked section are attached in order to keep the pivoting section 2422 away from the rail 140.

While the specific embodiments have been illustrated and described, numerous modifications come to mind without significantly departing from the spirit of invention and the scope of invention is only limited by the scope of accompanying claims.

What is claimed is:

1. A fence assembly for a cutting machine having a worktable, a rail and a ruler comprising:
a body mounted transverse to a longitudinal axis of the worktable of the cutting machine and adapted to move relative to the worktable; and
a coupling mechanism including a sliding bracket slidably mounted to the rail and connected to the body such that movement of the bracket along the rail causes movement of the body across the worktable, and the sliding bracket including a cross section defining a first, a second and a third sides corresponding with the rail for providing a stable sliding movement with respect to the rail, and with the second side interconnecting the first and third sides and with the first side spaced from the third side; and
a locking mechanism for selectively locking and unlocking the sliding bracket on the rail such that the body is prevented from movement with respect to the worktable when the sliding bracket is locked and the body is enabled to move with respect to the worktable when the sliding bracket is unlocked.

2. The fence assembly as claimed in claim 1 wherein the body includes a first end near which a lifting mechanism is mounted for adjusting a height between the body and the worktable, and a second end at which the locking mechanism is pivotally connected.

3. The fence assembly as claimed in claim 2 wherein the locking mechanism includes a handle operably urging a pivoting member to selectively engage with and disengage from the rail such that when the pivoting member is engaged with the rail the sliding bracket is locked and when the pivoting member is disengaged from the rail the sliding bracket is unlocked.

4. The fence assembly as claimed in claim 3 wherein the pivoting member has a substantially uniform thickness and includes a rolled hooked section as a pivot and a planar pivoting section adapted to pivot with respect to the hooked section, and wherein the handle includes a grip at one end thereof for user to hold to operate the handle and a cam at another end thereof for urging the pivoting section to selectively engage with and disengage from the rail.

5. The fence assembly as claimed in claim 4 wherein the hooked section of the pivoting member and the cam of the handle are installed to a bracket extended from the second end of the body, and wherein the hooked section includes a first fastener and the cam includes a second fastener inserted threrethrough, respectively, for engagement with the bracket.

6. The fence assembly as claimed in claim 5, wherein the cam defines a first and a second points at the periphery thereof, respectively, and with first point and the second fastener defining a first radius and with the second point and the second fastener defining a second radius, with the first radius being longer than the second radius, and wherein the first point abuts the pivoting section of the pivoting member when the pivoting member and the rail are engaged, and wherein the second point abuts the pivoting section of the pivoting member when the pivoting member and the rail are disengaged.

7. The fence assembly as claimed in claim 4 wherein the handle includes a magnet selectively attaching and detaching the hooked section, and wherein the magnet and the hooked section are attached when the pivoting member and the rail are disengaged, and wherein the magnet and the hooked section are detached when the pivoting member and the rail are engaged.

8. The fence assembly as claimed in claim 2 wherein the lifting mechanism includes a sliding member, a polygonal member connected to the sliding member, a clip for preventing disengagement of the sliding member and polygonal member, a screw threadly engaged with the polygonal member, and a nut threadly engage with the screw.

9. The fence assembly as claimed in claim 1 further comprising a controlling member adapted to be inserted through the sliding bracket to abut the rail to thereby make appropriate tightness between engagement of the sliding bracket and rail.

10. The fence assembly as claimed in claim 1 further comprising an engaging member disposed between the first side of the sliding bracket and the rail, and wherein the engaging member is attached to the sliding bracket and includes an auxiliary engaging member and a cushioning member.

11. The fence assembly as claimed in claim 1 further comprising a measuring apparatus attached to the sliding bracket, and wherein the measuring apparatus includes a measuring indication window for user to read and get measurement from the ruler, and a calibrating member for calibration of the measuring apparatus.

12. A fence assembly for a cutting machine having a worktable, a rail and a ruler comprising:
a body mounted transverse to a longitudinal axis of the worktable of the cutting machine and adapted to move relative to the worktable; and
a coupling mechanism including a sliding bracket slidably mounted to the rail and connected to the body such that movement of the bracket along the rail cause movement of the body across the worktable, and the sliding bracket including a cross section defining a first, a second and a third sides corresponding with the rail for providing stable sliding movement with respect to the rail, and with the second side interconnecting the first and third sides and with the first side spaced from the third side;
a locking mechanism for selectively locking and unlocking the sliding bracket on the rail such that the body is prevented from movement with respect to the worktable when sliding bracket is locked and the body is enabled to move with respect to the worktable when the sliding bracket is unlocked; and
a measuring apparatus attached to the sliding bracket and includes a measuring indication window for user to read and get measurement from the ruler, and a calibrating member for calibration of the measuring apparatus.

13. The fence assembly as claimed in claim 12 wherein the body includes a first end near which a lifting mechanism is mounted for adjusting a height between the body and the worktable, and a second end at which the locking mechanism is pivotally connected.

14. The fence assembly as claimed in claim 13 wherein the locking mechanism includes a handle operably urging a pivoting member to selectively engage with and disengage from the rail such that when the pivoting member is engaged with the rail the sliding bracket is locked and when the pivoting member is disengaged from the rail the sliding bracket is unlocked.

15. The fence assembly as claimed in claim 14 wherein the pivoting member has a substantially uniform thickness and includes a rolled hooked section as a pivot and a planar pivoting section adapted to pivot with respect to the hooked section, and wherein the handle includes a grip at one end thereof for user to hold to operate the handle and a cam at another end thereof for urging the pivoting section to selectively engage with and disengage from the rail.

16. The fence assembly as claimed in claim 15 wherein the hooked section of the pivoting member and the cam of the handle are installed to a bracket extended from the second end of the body, and wherein the hooked section includes a first fastener and the cam includes a second fastener inserted threrethrough, respectively, for engagement with the bracket.

17. The fence assembly as claimed in claim 16, wherein the cam defines a first and a second points at the periphery thereof, respectively, and with the first point and the second fastener defining a first radius and with the second point and the second fastener defining a second radius, with the first radius being longer than the second radius, and wherein the first point abuts the pivoting section of the pivoting member when the pivoting member and the rail are engaged, and wherein the second point abuts the pivoting section of the pivoting member when the pivoting member and the rail are disengaged.

18. The fence assembly as claimed in claim 14 wherein the handle includes a magnet selectively attaching and detaching the hooked section, and wherein the magnet and the hooked section are attached when the pivoting member and the rail are disengaged, and wherein the magnet and the hooked section are detached when the pivoting member and the rail are engaged.

19. The fence assembly as claimed in claim 12 wherein the lifting mechanism includes a sliding member, a polygonal member securely attached to the sliding member by a clip, a screw adapted to threadly engage with the polygonal member, and a nut adapted to threadly engage with the screw.

20. The fence assembly as claimed in claim 12 further comprising an engaging member disposed between the first side of the sliding bracket and the rail, and wherein the engaging member is attached to the sliding bracket and includes an auxiliary engaging member and a cushioning member
